(19) United States
(12) Patent Application Publication
(10) Pub. No.: US 2008/0032172 A1
(43) Pub. Date: Feb. 7, 2008

(54) Conductive coating for solid oxide fuel cell

(76) Inventors: Subhasish Mukerjee, Pittsford, NY (US); Karl J. Haltiner, Fairport, NY (US); Kerry Duane Meinhardt, Kennewick, WA (US); Jin Yong Kim, Richland, WA (US); Eric Mast, Richland, WA (US); Vincent Lee Sprenkle, Richland, WA (US)

Correspondence Address: DELPHI TECHNOLOGIES, INC., M/C 480-410-202, PO BOX 5052, TROY, MI, 48007, US

(21) Appl. No.: 11/499,583

(22) Filed: Aug. 4, 2006

(51) Int. Cl. H01M 8/12; H01M 8/24

(52) U.S. Cl. 429/32; 429/34

(57) ABSTRACT

A solid oxide fuel cell stack that contains a plurality of fuel cells, each of which includes an anode and a cathode disposed on opposite sides of a solid electrolyte, and an electrically conductive interconnect disposed between the anode and cathode. The interconnect includes a substrate and a first surface in electrical contact with the anode and a second surface in electrical contact with the cathode, wherein at least a portion of at least one of the surfaces includes cobalt.

This invention was made with United States Government support under Government Contract/Purchase Order No. DE-FC26-02NT41246. The Government has certain rights in this invention.

### TECHNICAL FIELD

The present invention relates to fuel cells, more particularly to solid-oxide fuel cells, and most particularly to a solid oxide fuel cell stack that includes a cobalt-containing interconnect surface.

### BACKGROUND OF THE INVENTION

A fuel cell is an energy conversion device that generates electricity and heat by electrochemically combining a gaseous fuel, for example, hydrogen, carbon monoxide, or a hydrocarbon, with an oxidant such as air or oxygen, across an ion-conducting electrolyte. The fuel cell converts chemical energy into electrical energy, which may then be used by a high-efficiency electric motor, or stored. A solid oxide fuel cell (SOFC) is frequently constructed of solid-state materials, typically utilizing an ion conductive oxide ceramic as the electrolyte. A conventional electrochemical cell in a SOFC is comprised of an anode and a cathode with an electrolyte disposed therebetween. The oxidant passes over the oxygen electrode or cathode while the fuel passes over the fuel electrode or anode, generating electricity, water, and heat.

In a typical SOFC, a fuel flows to the anode where it is oxidized by oxygen ions from the electrolyte, producing electrons that are released to the external circuit, and mostly water and carbon dioxide are removed in the fuel flow stream. At the cathode, the oxidant accepts electrons from the external circuit to form oxygen ions. The oxygen ions migrate across the electrolyte to the anode. The flow of electrons through the external circuit provides for consumable or storable electricity. However, each individual electrochemical cell generates a relatively small voltage. Higher voltages may be attained by electrically connecting a plurality of electrochemical cells in series to form a stack.

U.S. Pat. No. 6,737,182, the disclosure of which is incorporated herein by reference, discloses a solid oxide fuel cell stack comprising an electrochemical cell that has an electrolyte disposed between and in ionic communication with a first and second electrode, and an interconnect that is in fluid and thermal communication with at least a portion of the electrochemical cell, the interconnect being configured to receive electrical energy and thereby act as a heating element.

U.S. Patent Application Publication No. 2005/0153190, the disclosure of which is incorporated herein by reference, discloses a solid oxide fuel cell stack that comprises flexible thin foil interconnect elements and thin spacer elements that can conform to nonplanarities in the stack's electrolyte elements, thereby avoiding the inducing of torsional stresses in the electrolyte elements.

### SUMMARY OF THE INVENTION

The present invention is directed to a solid oxide fuel cell stack that comprises a plurality of fuel cells, each of which comprises an anode and a cathode disposed on opposite sides of a solid electrolyte, and an electrically conductive interconnect disposed between the anode and cathode. The interconnect comprises a substrate and a first surface in electrical contact with the anode and a second surface in electrical contact with the cathode, wherein at least a portion of at least one of the surfaces comprises cobalt.

### BRIEF DESCRIPTION OF THE DRAWINGS

The present invention will now be described, by way of example, with reference to the accompanying drawings, in which:

FIG. 1 is a schematic cross-sectional view of a two-cell stack of solid oxide fuel cells in accordance with the present invention.

FIG. 2 is a graph containing a series of power vs. time curves that demonstrate the advantage of coating a chromium alloy interconnect with a cobalt-containing layer in accordance with the present invention.

### DESCRIPTION OF THE PREFERRED EMBODIMENTS

Solid oxide fuel cell stacks typically include interconnects fabricated from metallic materials, which are commonly chromium-containing metal alloys. Fuel cell cathodes are typically formed from mixed oxides such as perovskites ABO₃, where A represents a metal such as lanthanum, cerium, calcium, sodium, strontium, lead, praseodymium, rare earth metals and mixtures thereof, and B represents titanium, niobium, iron, cobalt, manganese, nickel and mixtures thereof.

Under typical high temperature operating conditions, e.g., about 750° C., the chromium included in the alloy volatilizes and reacts with oxygen and moisture from the air to generate chromium oxide and other related species, as shown below:

2Cr+1.5O₂→Cr₂O₃

Cr₂O₃+O₂(g)+H₂O(g)→2CrO₂(OH)₂(g)

Cr₂O₃ and CrO₂(OH)₂ in the gas phase undergo reaction with the cathode and degrade its performance and durability. This adverse effect is prevented or mitigated by the present invention.

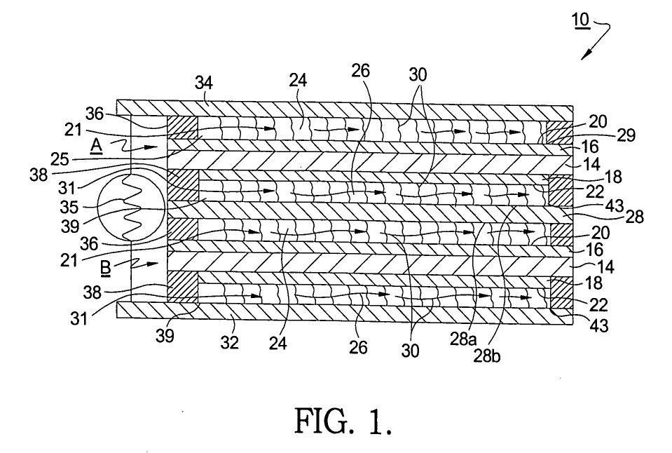

Referring to FIG. 1, a fuel cell stack 10 includes elements normal in the art to solid oxide fuel cell stacks comprising more than one fuel cell. The example shown includes two fuel cells A and B, connected in series, and is of a class of such fuel cells said to be “anode-supported” in that the anode is a structural element having the electrolyte and cathode deposited upon it. Element thicknesses as shown are not to scale.

Each fuel cell includes a solid electrolyte 14 separating an anode 16 and a cathode 18. Each anode and cathode is in direct chemical contact with its respective surface of the electrolyte, and each anode and cathode has a respective free surface 20, 22 forming one wall of a respective passageway 24, 26 for flow of gas across the surface. Anode 16 of fuel cell B faces and is electrically connected to an interconnect 28 by filaments 30 extending across but not blocking passageway 24, and cathode 18 of fuel cell A faces and is electrically connected to interconnect 28 by filaments 30 extending across but not blocking passageway 26. Similarly, cathode 18 of fuel cell B faces and is electrically connected to a cathodic current collector 32 by filaments 30 extending across but not blocking passageway 26, and anode 16 of fuel cell A faces and is electrically connected to an anodic current collector 34 by filaments 30 extending across but not blocking passageway 24.

Current collectors 32, 34 may be connected across a load 35 to enable the fuel cell stack 10 to perform electrical work. Passageways 24 are formed by anode spacers 36 between the perimeter of anode 16 and either interconnect 28 or anodic current collector 34. Passageways 26 are formed by cathode spacers 38 between the perimeter of electrolyte 14 and either interconnect 28 or cathodic current collector 32.

Interconnect 28 disposed between anode 16 and cathode 18 comprises a first surface 28a in electrical contact with anode 16 and a second surface 28b in electrical contact with cathode 18. Interconnect 28 is formed from a metal or metal alloy that typically includes chromium, for example, an iron-chromium alloy.

In the operation of fuel cell stack 10, reformate gas 21 is provided to passageways 24 at a first edge 25 of the anode free surface 20, flows parallel to the surface 20 of anode 16 across the anode in a first direction, and is removed at a second and opposite edge 29 of anode surface 20. Hydrogen and CO diffuse into anode 16 to the interface with electrolyte 14. Oxygen 31, typically in air, is provided to passageways 26 at a first edge 39 of the cathode free surface 22, flows parallel to the surface of cathode 18 in a second direction (omitted for clarity in FIG. 1) that is orthogonal to the first direction of the reformate flow, and is removed at a second and opposite edge 43 of cathode surface 22. Molecular oxygen gas diffuses into cathode 18 and is catalytically reduced to two oxygen ions by accepting four electrons from cathode 18 and cathodic current collector 32 of cell B or interconnect 28 of cell A via filaments 30. Electrolyte 14 is permeable to the oxygen ions that pass by electric field through the electrolyte and combine with four hydrogen atoms to form two water molecules, giving up four electrons to anode 16 and anodic current collector 34 of cell A or interconnect 28 of cell B via filaments 30. Thus, cells A and B are connected in series electrically between the two current collectors 32 and 34, and the total voltage and wattage between the current collectors is the sum of the voltage and wattage of the individual cells in fuel cell stack 10.

In accordance with the present invention, at least a portion of at least one of surfaces 28a and 28b of interconnect 28 comprises a layer of metallic cobalt, cobalt oxide, or a mixture thereof. A layer of metallic cobalt, which may be formed by, for example, electroplating, has a thickness preferably of about 0.5 micron to about 10 microns, more preferably, about 2.5 microns to about 5 microns. The metallic cobalt layer may be subjected to oxidizing conditions by, for example, heating in an oxygen-containing atmosphere to a temperature of about 800° C. for a period of about 15 minutes to about 8 hours, causing at least a portion of the metallic cobalt to be oxidized to cobalt oxide. The metallic cobalt can also be diffused into the surface of the chromium alloy substrate by heating to about 800° C. in a vacuum or in a non-oxidative atmosphere for a period of about 15 minutes to about 8 hours. This latter treatment produces a cobalt rich surface that, upon subsequent exposure to a controlled oxygen-containing atmosphere during the cooling phase of the cycle, can form a cobalt oxide layer.

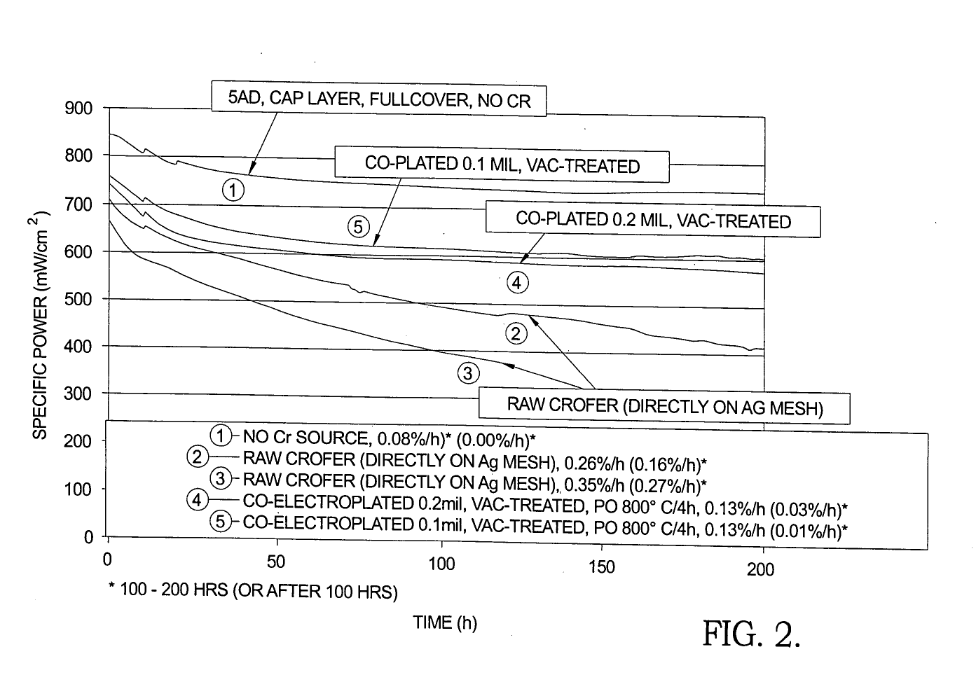

FIG. 2 is a graph containing a series of plots of specific power in mW/cm² vs. time in hours that demonstrate the beneficial effect of coating a chromium alloy sample, representative of a fuel cell interconnect, with a cobalt-containing layer in accordance with the present invention.

Tests were carried out using a button cell having a 2.83 cm² active area and 5% A-site deficient LSCF6428 lanthanum-strontium-iron-cobaltite (La_{0.6}Sr_{0.4})_{0.95}Co_{0.2}Fe_{0.8}O₃) cathode. A series of uncoated and coated Crofer 22 APU alloy discs, representing the interconnect alloy, were placed on top of a Ag current collecting mesh that is in contact with a fully covered Ag—Pd metallization layer of the cathode. Crofer discs were coated with Co-containing layers of 0.1 mil (2.5 microns) and 0.2 mil (5 microns). Before being placed on the cathode for testing, the electroplated Crofer discs were vacuum-treated and pre-oxidized at 800° C. for 4 hours to form a continuous Co oxide layer on the Crofer disc surface.

The results of coated Crofer samples are compared with the cells containing no Cr source (curve 1 of FIG.2) and uncoated Crofer discs (curves 2 and 3 of FIG. 2). As shown by the test results, Cr poisoning of the cathode was significantly reduced for the Co-coated Crofer discs (curves 4 and 5 of FIG. 2) compared with the uncoated Crofer disc, with a fade rate of 0.01˜0.03%/h vs. 0.16˜0.27%/h at 100-200 hrs. Even though initial power densities of the Co-coated samples were slightly lower than that of the no-Cr sample, possibly due to initial Cr poisoning before testing, their fade rate were comparable to the baseline cathode performance of the no-Cr baseline source.

As demonstrated by the foregoing results, the layer of metallic cobalt, cobalt oxide, or mixture thereof is highly is highly effective in preventing formation of chromium oxide and other related species, and its subsequent detrimental reaction with the cathode. In addition, the resulting surface has high electrical conductivity that is stable over extended time in the high temperature operating environment. Similar results have also been obtained by deposition of the Co layer using other processes such as physical vapor deposition (PVD) or chemical vapor deposition (CVD).

While the invention has been described by reference to various specific embodiments, it should be understood that numerous changes may be made within the spirit and scope of the inventive concepts described. Accordingly, it should be recognized that the invention is not limited to the described embodiments but has full scope defined by the language of the following claims.

What is claimed is:

1. A solid oxide fuel cell stack comprising: a plurality of fuel cells, each of said fuel cells comprising an anode and a cathode disposed on opposite sides of a solid electrolyte, and an electrically conductive interconnect disposed between said anode and said cathode, said interconnect comprising a substrate and a first surface in electrical contact with said anode and a second surface in electrical contact with said cathode, at least a portion of at least one of said surfaces comprising cobalt.

2. The solid oxide fuel stack of claim 1 wherein said substrate comprises a metal.

3. The solid oxide fuel stack of claim 2 wherein said metal comprises chromium.

4. The solid oxide fuel stack of claim 3 wherein said metal comprises an iron-chromium alloy

5. The solid oxide fuel stack of claim 1 wherein said at least a portion of at least one of said surfaces comprises cobalt, cobalt oxide, or a mixture thereof.

6. The solid oxide fuel stack of claim 1 wherein said at least a portion of at least one of said surfaces comprises a layer of metallic cobalt.

7. The solid oxide fuel stack of claim 6 wherein said layer of metallic cobalt has a thickness of about 0.5 micron to about 10 microns.

8. The solid oxide fuel stack of claim 7 wherein said layer of metallic cobalt has a thickness of about 2.5 microns to about 5 microns.

9. The solid oxide fuel stack of claim 6 wherein said layer of metallic cobalt is formed on said surface by electroplating.

10. The solid oxide fuel stack of claim 6 wherein said layer of metallic cobalt is formed on said surface by a physical vapor deposition process.

11. The solid oxide fuel stack of claim 6 wherein said layer of metallic cobalt is formed on said surface by a chemical vapor deposition process.

12. The solid oxide fuel stack of claim 6 wherein said layer of metallic cobalt is subjected to oxidizing conditions, thereby causing at least a portion of said metallic cobalt to be oxidized to cobalt oxide.

13. The solid oxide fuel stack of claim 12 wherein said oxidizing conditions comprise heating said layer in an oxygen-containing atmosphere to a temperature of about 800° C. for a time period of about 15 minutes to about 8 hours.

14. The solid oxide fuel stack of claim 6 wherein said layer of metallic cobalt is subjected to reducing conditions, thereby causing at least a portion of said metallic cobalt to diffuse into said substrate.

15. The solid oxide fuel stack of claim 14 wherein said reducing conditions comprise heating said layer to about 800° C. in a vacuum or in a non-oxidative atmosphere.

16. The solid oxide fuel stack of claim 14 wherein, following said reducing conditions, said metallic cobalt is exposed to a an oxygen-containing atmosphere during cooling, thereby forming cobalt oxide.
